(19) United States
(12) Patent Application Publication
(10) Pub. No.: US 2026/0301453 A1
(43) Pub. Date: Oct. 1, 2026

(54) DYNAMIC CONTENT RECOGNITION AND CONVERSION METHOD, APPARATUS AND DEVICE AND STORAGE MEDIUM

(71) Applicant: Meiimo Technology (Guangzhou) Co., Ltd., Guangzhou (CN)

(72) Inventor: WENHSIANG CHIANG, Guangzhou (CN)

(21) Appl. No.: 19/651,072

(22) Filed: Apr. 17, 2026

Related U.S. Application Data
(63) Continuation of application No. PCT/CN2025/101412, filed on Jun. 17, 2025.

(30) Foreign Application Priority Data
Mar. 25, 2025 (CN) 202510358725.6

(51) Int. Cl. G06V 30/148; G06F 16/11

(52) U.S. Cl. CPC G06V 30/153; G06F 16/116

(57) ABSTRACT

The present application relates to the technical field of image data processing, in particular to a dynamic content recognition and conversion method, apparatus and device and a storage medium. The method comprises: determining input contents and a content type thereof in a whiteboard; and determining a target conversion file of the input contents by using the content type. Through the dynamic content recognition and conversion method of the present application, the input contents are automatically analyzed and classified, and the input contents are quickly converted into various digital documents matched with the corresponding formats of the input contents. The method is suitable for multiple application scenarios of education, meetings, business management, process design, etc., significantly increases decision-making and execution efficiency, and increases the working efficiency of standard normalized content output.

### CROSS REFERENCE TO RELATED APPLICATIONS

This application is a Continuation of International Application No. PCT/CN2025/101412 filed on June, 17, 2025, which claims priority to Chinese Patent Application No. 202510358725.6 on filed March 25, 2025 under 35 U.S.C. § 119; the entire contents of all of which are hereby incorporated by reference.

### TECHNICAL FIELD

The present application relates to the technical field of image data processing, in particular to a dynamic content recognition and conversion method, apparatus and device and a storage medium.

### BACKGROUND

At present, both traditional whiteboards and electronic whiteboards are mainly used for collaboration and visual discussion, and focus on the recognition and the storage of static contents, but lack effective content analysis and automatic format conversion functions, and learning and optimization for a dynamic discussion process. The existing whiteboard systems generally only recognize the final written contents and cannot analyze the thinking paths of users during meetings or discussion. In addition, the electronic whiteboard tools on the market at present only support basic hand-drawn conversion and summary note recording, and lack the automatic classification and analysis functions for presented and shared contents, causing that output results are mostly image files and PDF (Portable Document Format) which is essentially the image file. This does not conform to the needs during the actual execution of the work. Therefore, there is an urgent need for an intelligent whiteboard system that can intelligently learn the drawing and discussion processes automatically, analyze the contents and quickly convert the contents into standard digital format files to improve working efficiency and decision-making accuracy.

### SUMMARY

To solve the technical problems of the deficiency and the inefficiency of the automatic classification and analysis functions of whiteboard contents in the existing whiteboard system, the purpose of the present application is to provide a dynamic content recognition and conversion method, apparatus and device and a storage medium. The adopted technical solution is specifically as follows:

The present application provides a dynamic content recognition and conversion method which comprises:
determining input contents and a content type thereof in a whiteboard;
determining a target conversion file of the input contents by using the content type.

Preferably, the input contents comprise at least one of hand-drawn information, speech information and text information.

Preferably, the content type comprises at least one of a table, a presentation, a text document and a digital chart.

Preferably, the digital chart comprises at least one of a flow chart, a Gantt chart, a mind map, a decision tree diagram, a data flow diagram, an organization chart, a tree structure diagram and a network topology diagram.

Preferably, determining input contents and a content type thereof in a whiteboard comprises:
recognizing the input contents in the whiteboard in real time and determining a matching degree between the input contents and each preset file template;
determining a file type of a target preset file template with a highest matching degree as the content type of the input contents.

Preferably, determining a target conversion file of the input contents by using the content type comprises:
mapping the input contents to the target preset file template to generate the target conversion file in a corresponding document format.

Preferably, recognizing the input contents in the whiteboard in real time and determining a matching degree between the input contents and each preset file template further comprises: determining user information of a current user using the whiteboard;
correcting the matching degree between the input contents and each preset file template by using preference information in the user information.

Preferably, determining input contents and a content type thereof in a whiteboard comprises:
determining content time series data of the input contents in the whiteboard;
adjusting and determining the content type of the input contents in real time by using the content time series data.

Preferably, the input contents comprise the hand-drawn information, and determining input contents and a content type thereof in a whiteboard comprises:
determining word information in the hand-drawn information by using optical character recognition;
determining the content type corresponding to the word information by using natural language processing.

Preferably, the input contents comprise the hand-drawn information, and determining input contents and a content type thereof in a whiteboard comprises:
determining graphic information in the hand-drawn information by using image recognition;
determining the content type corresponding to the graphic information by using a deep learning model.

Preferably, determining the content type corresponding to the graphic information by using a deep learning model comprises:
segmenting the graphic information by using a Mask R-CNN model and determining geometry structures in the graphic information by using a YOLO algorithm;
determining the content type corresponding to the graphic information by using each geometry structure.

Preferably, the input contents comprise multimodal information composed arbitrarily of the hand-drawn information, the speech information and the text information; and determining input contents and a content type thereof in a whiteboard comprises:
determining text data, speech data and geometry data in the hand-drawn information, the speech information and the text information;
determining the content type corresponding to the multimodal information in combination by using the text data, the speech data, the geometry data and respective modal weights.

The present application further provides a dynamic content recognition and conversion apparatus which is used for achieving any one of the dynamic content recognition and conversion methods; and the apparatus comprises:
a content recognition module used for determining input contents and a content type thereof in a whiteboard;
a data conversion module used for determining a target conversion file of the input contents by using the content type.

The present application further provides a dynamic content recognition and conversion device which comprises a processor, a memory and computer programs stored in the memory and capable of being executed by the processor, wherein the computer programs, when executed by the processor, implement the steps of any one of the dynamic content recognition and conversion methods.

The present application further provides a computer readable storage medium which stores computer program instructions; and the program instructions, when executed by a processor, implement the steps of any one of the dynamic content recognition and conversion methods.

The present application further provides a computer program product which, when run on a computer, makes the computer execute any one of the dynamic content recognition and conversion methods.

The present application has the following beneficial effects:
The present application proposes a dynamic content recognition and conversion method which supports multiple input contents and modes (such as electronic whiteboards, traditional whiteboards and speech input). Besides gradually learning the input contents and optimizing content recognition and judgment in the process of discussing and drawing the contents, the method can also automatically analyze and classify the contents and quickly convert the input contents into various digital documents matched with the corresponding formats of the input contents, thereby being suitable for scenarios of education, meetings, business management, process design, etc., significantly increasing decision-making and execution efficiency, automatically collating relatively disorganized input contents, increasing the working efficiency of standard normalized content output, reducing the error rate of manual processing and the complexity of outputting files in corresponding formats and applying to various application scenarios.

### DESCRIPTION OF DRAWINGS

To more clearly describe the technical solutions and the advantages in embodiments of the present application or in the prior art, the drawings required to be used in the description of the embodiments or the prior art will be simply presented below. Apparently, the drawings in the following description are merely some embodiments of the present application, and for those ordinary skilled in the art, other drawings can also be obtained according to these drawings without contributing creative labor.

FIG. 1 is a flow chart 1 of a dynamic content recognition and conversion method shown in an exemplary embodiment of the present application;

FIG. 2 is a flow chart 2 of a dynamic content recognition and conversion method shown in another exemplary embodiment of the present application;

FIG. 3 is a flow chart 3 of a dynamic content recognition and conversion method shown in another exemplary embodiment of the present application;

FIG. 4 is a flow chart 4 of a dynamic content recognition and conversion method shown in another exemplary embodiment of the present application;

FIG. 5 is a flow chart 5 of a dynamic content recognition and conversion method shown in another exemplary embodiment of the present application;

FIG. 6 is a structural schematic diagram of a hardware operating environment of a dynamic content recognition and conversion device involved in a solution of an embodiment of the present application;

FIG. 7 is a schematic diagram of a frame structure of a dynamic content recognition and conversion apparatus involved in a solution of an embodiment of the present application.

### DETAILED DESCRIPTION

To further explain the technical means adopted by the present application to achieve the intended application purpose and the effect, a dynamic content recognition and conversion method proposed based on the present application, specific implementation modes, structures, features and effects are explained in detail below in combination with drawings and preferred embodiments. In the following description, different “one embodiment” or “another embodiment” shall not necessarily refer to the same embodiment. In addition, the specific features, structures or characteristics in one or more embodiments can be combined in any appropriate form.

Unless otherwise defined, all technical and scientific terms used herein have the same meanings as those generally understood by those skilled in the art in the present application.

Specific solutions of a dynamic content recognition and conversion method provided by the present application will be described specifically below in combination with drawings.

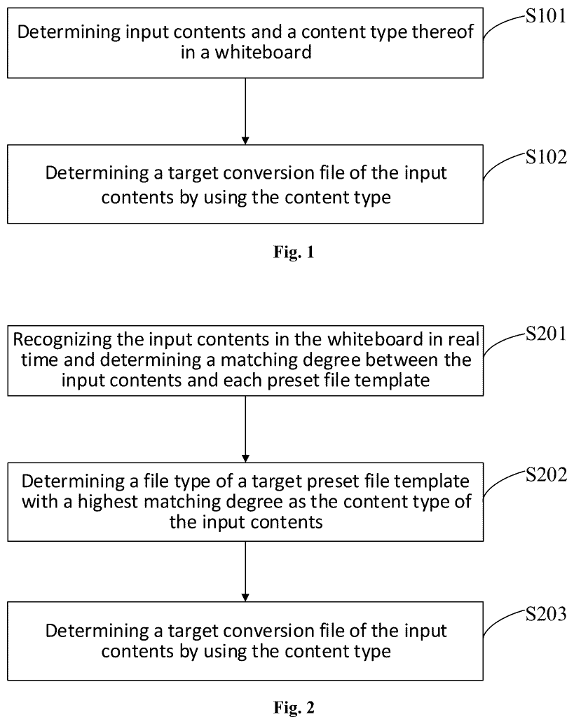

For a dynamic content recognition and conversion method provided by the present application, in one embodiment, by referring to FIG. 1, FIG. 1 is a flow chart 1 of a dynamic content recognition and conversion method shown in an exemplary embodiment of the present application.

The method is applied to a whiteboard, and comprises:
Step S101: determining input contents and a content type thereof in a whiteboard;
Step S102: determining a target conversion file of the input contents by using the content type.

In the present embodiment, the whiteboard can be an electronic whiteboard or a traditional whiteboard.

For the electronic whiteboard, the input contents which are input into the whiteboard can be collected by a mode of stroke drawing on a touch display screen of the electronic whiteboard, or surrounding speech signals can be collected through a sound collection module of the electronic whiteboard, i.e., a microphone generally, or electronic files and other electronic information can be acquired through data transmission modes such as USB, wireless mode, etc.

For the traditional whiteboard, word symbols and graphics written and drawn in the traditional whiteboard can be acquired by arranging cameras to collect images. The cameras can be arranged in such a manner that the cameras are arranged directly opposite and slightly above the traditional whiteboard or at other positions in which a larger field of view can be acquired, and at a preset distance from the traditional whiteboard.

The input contents in the whiteboard can comprise at least one or any combined information of more of hand-drawn information, speech information and text information.

Wherein the hand-drawn information comprises hand-drawn characters such as words and numbers, and line graphic structures such as arrows, straight lines, curves, squares and circles, and of course, can also comprise any other symbols and graphics that can be presented through a hand-drawing mode.

The content type of the input contents comprises at least one of a table, a presentation, a text document and a digital chart.

Wherein the digital chart comprises at least one of a flow chart, a Gantt chart, a mind map, a decision tree diagram, a tree structure diagram, a data flow diagram, an organization chart, a network topology diagram, a timeline chart, a time plan, a calendar, a scalable vector graphic and other charts.

In addition, the content types can also be classified in the following modes:
Type 1: creativity and thinking organization, comprising:
Mind map: suitable for creativity divergence and brainstorming results.
Use case diagrams: suitable for demand analysis and system interaction design.
Type 2: project management and time planning, comprising:
Gantt chart: suitable for schedule planning and project management.
Timeline chart: suitable for project time arrangement and progress monitoring.
Auto-schedule calendar: suitable for time management and task planning.
Type 3: business and process management, comprising:
Visio flow chart: suitable for process design and business optimization.
BPMN (Business Process Modeling Notation) process script: suitable for business process modeling and automated execution.
Visual workflow: suitable for operation processes and visual guidance.
Type 4: data analysis and decision support, comprising:
Excel form: suitable for data analysis and report management.
Decision tree diagram: suitable for decision analysis and process selection.
Data flow diagram: suitable for data flow and process analysis.
Type 5: structure and network planning, comprising:
Organization chart: suitable for organizational structure planning and management.
Architecture diagrams: suitable for system design and structural analysis.
Network topology diagrams: suitable for network structure planning and analysis.
Tree structure diagrams: suitable for hierarchical visualization and analysis.
Type 6: display and archiving, comprising:
PowerPoint briefing: suitable for presentations and proposal reports.
PDF document: suitable for archiving and sharing of standardized files.

SVG (Scalable Vector Graphics): suitable for visual display and editing.
For recognition and classification of the input contents, character symbols such as words and numbers therein can be recognized through the currently mature optical character recognition (OCR) technology, text information composed of words can be recognized through the natural language processing (NLP) technology, and graphic features in the input contents can also be extracted and the graphic structures can be distinguished through the existing neural network models used for recognizing graphic information. The speech information of the input contents can be recognized through some speech recognition models, and the speech information can be denoised and then converted into text information or other information.

After the content type of the input contents is determined, a preset file template matched with the content type can be retrieved. The input contents are directly converted into graphic materials in the preset file template or the contents are converted into characters and schemata in standard formats and then filled into corresponding positions in the preset file template, thereby generating a target conversion file that conforms to corresponding file specification standards. For example, after determining that the hand-drawn information is the arrow in the flow chart, the hand-drawn information can be converted into standard arrow material in a flow chart file template; and for example, after determining that the hand-drawn information is a hand-drawn table, the data in the hand-drawn table can be converted into a standard font format and then filled into a table file template, or the data and table frame lines in the hand-drawn table are simultaneously converted into frame lines and data in a standard spreadsheet. If the input contents are speech information, the speech information can be at least converted into text documents or presentation documents in various formats. In addition, the content type corresponding to the hand-drawn information can be further determined through the speech information, so as to convert the hand-drawn information into a target conversion file that better conforms to the actual needs of users. If the input contents themselves are the speech information, the speech information can be converted into text documents or presentation documents in other formats.

Embodiments of the present application propose a dynamic content recognition and conversion method which supports multiple input contents and modes (such as electronic whiteboards, traditional whiteboards and speech input). Besides gradually learning the input contents and optimizing content recognition and judgment in the process of discussing and drawing the contents, the method can also automatically analyze and classify the contents and quickly convert the input contents into various digital documents matched with the corresponding formats of the input contents, thereby being suitable for scenarios of education, meetings, business management, process design, etc., significantly increasing decision-making and execution efficiency, automatically collating relatively disorganized input contents, increasing the working efficiency of standard normalized content output, reducing the error rate of manual processing and the complexity of outputting files in corresponding formats and applying to various application scenarios.

For a dynamic content recognition and conversion method provided by the present application, in one embodiment, by referring to FIG. 2, FIG. 2 is a flow chart 2 of a dynamic content recognition and conversion method shown in another exemplary embodiment of the present application.

In the present embodiment, the method comprises:
Step S201: recognizing the input contents in the whiteboard in real time and determining a matching degree between the input contents and each preset file template;
Step S202: determining a file type of a target preset file template with a highest matching degree as the content type of the input contents;
Step S203: determining a target conversion file of the input contents by using the content type.

In the present embodiment, the input contents which are inputted into the whiteboard can be dynamically acquired and recognized in real time. By recognizing and analyzing the input contents through a deep learning and neural network model, the input contents are inputted into the corresponding neural network model, such as a Transformer model. A data training set corresponding to the neural network model can comprise a large number of various file templates, including various tables, presentations, text documents, digital charts, etc. mentioned in the above embodiments, so that the matching degree, i.e., similarity, between the input contents and each preset file template is determined through a trained neural network model. The target preset file template with the highest matching degree is determined as the content type of the input contents, and then the input contents are mapped and converted into the target conversion file according to the target preset file template.

In one specific embodiment, the input contents comprise the hand-drawn information; and the step S101 comprises:
determining word information in the hand-drawn information by using optical character recognition;
determining the content type corresponding to the word information by using natural language processing.

Handwritten words and symbols or digitized printed words and symbols can be recognized through the optical character recognition technology, and converted into editable texts, such as word document format or non-editable PDF document format.

The optical character recognition (OCR) technology can also process images and extract word information through a convolutional neural network (CNN).

The process generally comprises: image denoising →feature extraction→character segmentation →word recognition→result output.

Specific usable key models or tools comprise: Tesseract OCR software or other deep learning models (such as CRNN).

Wherein the optical character recognition mainly relies on the convolutional neural network (CNN) for image feature extraction and character recognition.

Meanwhile, the Tesseract OCR software can also be used as a basic tool, and combined with the deep learning model (such as CRNN) to improve the accuracy of handwriting recognition. Non-standard fonts are trained by enhancing a dataset (rotation, blurring, etc.). Convolution operation is used to extract local features in images, such as edge shapes of letters and numbers. An ReLU activation function can also be used in the process of model training to improve the extraction effect of nonlinear features. A CTC (Connectionist Temporal Classification) loss function is used to ensure that the order of output characters is matched with the input.

In addition, dynamic font adaptation can also be conducted: based on a multimodal learning technology, the recognition accuracy of handwritten and non-standard fonts is enhanced, and the size of convolution kernels is dynamically adjusted through a feature adaptive layer.

More specifically, for the deep learning model used, CRNN (Convolutional Recurrent Neural Network) is used for explanation, and the CRNN is used for character detection and sequence prediction:
Wherein the convolutional layer: is used for extracting image features.

Wherein the RNN (Recurrent Neural Network) layer: processes sequence dependence and generates a character order.

The CTC loss function: ensures that the output character sequence is consistent with the character order in the image.

The OCR technology can be used for extracting words from the contents displayed from an electronic whiteboard or obtained through data transmission, or the contents photographed on a traditional whiteboard. This applies to the digitization of meeting minutes or class notes. Examples of application scenarios are as follows:
Scenario 1: automatic archiving of meeting notes. Whiteboard words photographed are extracted into an editable text by using high-precision OCR to achieve the digitization of the meeting notes.
Scenario 2: digital archival transfer and archiving of files.

After the word information in the hand-drawn information is recognized, the natural language processing (NLP) technology can then be applied. Through the natural language processing technology, the text semantics of the entire or part of the word information can be analyzed, keywords, topics and classifications can be extracted, the phased contents of meeting or teaching discussion can be automatically recognized and the contents can be classified into topic categories such as brainstorming, strategic planning, business management, process design, etc. according to contexts. The input contents can also be classified and archived through this topic classification mode. Meanwhile, content marking and sentiment analysis can also be provided to improve classification accuracy.

Based on pre-trained language models, such as GPT (Generative Pre-trained Transformer) or BERT (Bidirectional Encoder Representations from Transformers), the semantics are analyzed and the contents are classified.

The process generally comprises: text word segmentation →keyword extraction→topic/content classification →semantic modeling →template recommendation and output.

Purpose: automatic classification and template matching to generate appropriate document formats.

A multi-head attention mechanism in the models helps the models to capture long-range dependencies in the input words, such as associations between sentence topics and details. The classification loss function ensures that the models can correctly distinguish different types of contents.

Sentiment analysis combined with session topic recognition: the semantic sentiment tendency is analyzed through language sentiment models (such as RoBERTa), and the session topic is recognized simultaneously in combination with the attention mechanism of the Transformer structure of the models to achieve the function of automatic text summarization.

Semantic categorization is conducted by using the pre-trained BERT model, and the topics of the contents are extracted in combination with sentence vectors (sentence embedding). The automatic generation of summaries and template recommendations is based on the Transformers structure.

The entire NLP mentioned above can be used for automatically classifying and analyzing the contents of the whiteboard words. For example, the meeting discussion is classified as “brainstorming” or “schedule planning”, and appropriate document templates are recommend, such as word documents, PDF documents, PPT presentation documents, electronic notes or other chart documents.

Two practical application scenarios are provided here:
Application scenario 1: generation of meeting minutes: the text discussed and drawn during the meeting is analyzed, key points are extracted and a summary is automatically generated.
Application scenario 2: course induction in educational scenarios: classroom dialog data and hand-drawn data are semantically classified and course notes are generated.

In another specific embodiment, the input contents comprise the hand-drawn information; and the step S101 comprises:
determining graphic information in the hand-drawn information by using image recognition;
determining the content type corresponding to the graphic information by using a deep learning model.

Determining the content type corresponding to the graphic information by using a deep learning model specifically comprises:
segmenting the graphic information by using a Mask R-CNN model and determining geometry structures in the graphic information by using a YOLO algorithm;
determining the content type corresponding to the graphic information by using each geometry structure.

In the present embodiment, the convolutional neural network (CNN) model can be applied to recognize graphic structures (such as arrows, lines, block diagrams, etc.) and to recognize hand-drawn graphics or whiteboard contents.

The process generally comprises: image segmentation →feature detection→mode matching →conversion to standardized data formats.

Purpose: a hand-drawn flow chart is converted into chart formats such as Visio or SVG (Scalable Vector Graphics).

Wherein a common semantic segmentation model such as U-Net has the core of downsampling and upsampling images.

Wherein Hu moment invariant features can also be applied to detect specific graphics (such as arrows or block diagrams), and these shapes can be converted into standard symbols in chart tools such as Visio or SVG.

The OpenCV technology and the YOLO algorithm (a real-time target detection algorithm) can also be used for detecting geometries (such as arrows, lines, rectangles, circles, polygons, etc.) on the whiteboard. Image segmentation is conducted in combination with Mask R-CNN, and each graphic is separated and marked.

The loss function in the CNN model is used for training the semantic segmentation model to distinguish the graphic regions from the background. Reinforcement learning for graphic detection can also be conducted: reinforcement learning is applied to the detection of the flow chart (arrows, block diagrams, etc.), and detection results are continuously optimized through environmental feedback. In addition, images can also be processed by using an FPN (Feature Pyramid Network), and detected in combination with multi-level features.

A core model for achieving the above image (graphic) recognition can be selected from: Mask R-CNN, which is a specific CNN model.

The functions and purposes comprise: detecting hand-drawn arrows, rectangles and circles in whiteboard images. A ResNet (residual network) is used as a feature extractor to generate regional proposals.

Data labeling and training for the model: a LabelImg tool is used for labeling the data, and converting the format into a COCO (Common Objects in Context) format.

A specific model deployment solution and key points can comprise:
Model servitization: Mask R-CNN is deployed by using TorchServe to write a custom model processor to return the detected graphic types and coordinates.

Edge deployment: a lightweight model (such as Mask R-CNN of MobileNet version) is deployed to a device end to process real-time whiteboard images. The hand-drawn flow charts and structural diagrams can be converted into standardized formats (such as Visio flow charts) by an image recognition technology.

Two practical application scenarios are provided here:
Application scenario 1: automatic conversion of design sketches: hand-drawn design drawings are converted into vector graphics, and are compatible with tools such as Visio or CAD.
Application scenario 2: digitalization of process management: the flow chart is recognized to generate standardized business process scripts.

In another embodiment, for cases where the input contents comprise speech information, the speech input is transcribed into words through a speech recognition technology and automatically classified through a semantic analysis model.

The speech is transcribed into words by using a deep learning speech model (such as Wav2Vec or DeepSpeech).

The process of speech recognition generally comprises: audio denoising →feature extraction →speech-to-text→semantic categorization.

Based on the use of the existing speech model, the process can also comprise the following key points:
The speech signal is represented by a Mel Frequency Cepstrum Coefficient (MFCC), and the speech model is trained based on the CTC (Connectionist Temporal Classification) loss function.

The MFCC is used for extracting the core features of a speech audio, and these features can be used for training the speech recognition models. The CTC loss function ensures that the output word sequence is consistent with the actual speech contents.

In the process of speech recognition, real-time speech transcription optimization can also be conducted: speech streams are processed by using attention-based acoustic models (such as LAS, Listen-Attend-Spell), and speech segmentation and speaker recognition can also be conducted. For example, speaker segmentation is conducted by using an x-vector technology to distinguish the contents of multiple speakers.

Taking the DeepSpeech model as an example, the implementation process of speech recognition comprises the following main links and tools to be used:
Speech-to-text transcription is conducted by using DeepSpeech, speech features are extracted through the MFCC, and time step feature dependencies are captured by using BiLSTM (Bidirectional Long Short-Term Memory).

Two practical application scenarios are provided here:
Application scenario 1: multilingual transcription in remote collaboration, which supports the generation of multilingual meeting minutes.
Application scenario 2: automatic generation of diagnostic records: speech description in medical scenarios is automatically transcribed into structured reports.

In another specific embodiment, the input contents comprise multimodal information composed arbitrarily of the hand-drawn information, the speech information and the text information; and the step S101 comprises:
determining text data, speech data and geometry data in the hand-drawn information, the speech information and the text information;
determining the content type corresponding to the multimodal information in combination by using the text data, the speech data, the geometry data and respective modal weights.

In the present embodiment, the input contents for the whiteboard may not be limited to single hand-drawn information, speech information or text information, but rather multimodal information combined by two or three or more types of information (the content type can be called mixed content). Multimodal data fusion needs to be conducted for the multimodal information, which mainly constructs a unified multimodal representation model by combining text, image and speech data.

The process can comprise: data preprocessing →multimodal feature extraction→fusion modeling→result output.

Purpose of the multimodal representation (learning) model: supporting multi-type input processing under complex scenarios (such as speech +image+text).

Fusion of multiple models: image, text and speech data are combined to generate multimodal representation.

Specifically, multimodal learning models can be constructed by using TensorFlow or PyTorch in combination with image, speech and text features. Modal weights are dynamically adjusted to enhance a fusion effect and improve the understanding ability of the mixed content.

Wherein one of the important capabilities of the multimodal learning models is adaptive weight fusion, that is, the weights of the data can be dynamically adjusted according to the importance of the input data modality, which refer to the respective modal weights of the hand-drawn information, the speech information or the text information, or the weights among the speech data, the graphic data and the text data here.

Specifically, for a content fusion strategy, BERT (Bidirectional Encoder Representations from Transformers) can be used to extract text embedding, the ResNet (Residual Neural Network) can be used to extract image embedding, and finally data fusion is conducted through a multimodal Transformer model.

A multimodal technology can fuse the speech, image and text data to generate a unified data representation to achieve more advanced content analysis. An exemplary application scenario is provided here:
Multimodal classroom note generation: the speech, the whiteboard content and note pictures are fused to generate a complete digital note.

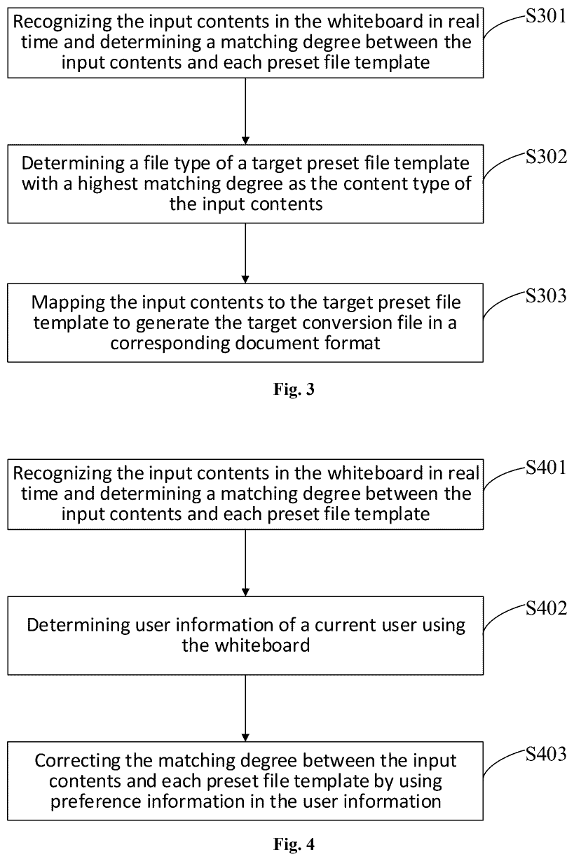

For a dynamic content recognition and conversion method provided by the present application, in one embodiment, by referring to FIG. 3, FIG. 3 is a flow chart 3 of a dynamic content recognition and conversion method shown in another exemplary embodiment of the present application.

In the present embodiment, the method comprises:
Step S301: recognizing the input contents in the whiteboard in real time and determining a matching degree between the input contents and each preset file template;
Step S302: determining a file type of a target preset file template with a highest matching degree as the content type of the input contents;
Step S303: mapping the input contents to the target preset file template to generate the target conversion file in a corresponding document format.

Based on the above embodiments, after the input contents and the content type of the input contents are recognized through a deep learning mode and the target preset file template matched therewith is determined, the recognized and classified input contents can be mapped to the target preset file template to generate the corresponding digital document format. That is, some irregular and discrete input contents are converted and filled into various standardized materials and elements in the target preset file template to form a corresponding standardized and structured target conversion file.

The present embodiment supports output in multiple document formats, including but not limited to:
Mind map: used for creativity organization and brainstorming.
Gantt chart: suitable for project schedule management.
Visio flow chart and organization chart: used for business process optimization and structural analysis.
Excel form: suitable for data analysis and financial management.
BPMN (Business Process Modeling Notation) process script: used for business process modeling and automated execution.
For a dynamic content recognition and conversion method provided by the present application, in one embodiment, by referring to FIG. 4, FIG. 4 is a flow chart 4 of a dynamic content recognition and conversion method shown in another exemplary embodiment of the present application.

The method comprises:
Step S401: recognizing the input contents in the whiteboard in real time and determining a matching degree between the input contents and each preset file template;
Step S402: determining user information of a current user using the whiteboard;
Step S403: correcting the matching degree between the input contents and each preset file template by using preference information in the user information.

Based on the above embodiments, after the matching degree between the input contents and each preset file template is preliminarily obtained, the matching degree between the input contents and each preset file template can be optimized and adjusted by analyzing the relevant information of the users for the purpose of making the final matching target preset file template and the generated target conversion file conform to the actual needs and usage habits of the users.

The present embodiment can determine the preference information of the users by analyzing the historical usage behaviors of the users based on the reinforcement learning model according to the preference information of the users, such as a file format that the user tends to use or is accustomed to using. For example, based on the target template file that the user independently selects after drawing on the whiteboard, or the setting of the own preference of the user in the early stage of using the whiteboard, a whiteboard system can provide corresponding option contents accordingly. The users can freely set that the whiteboard system automatically generates the corresponding target conversion file after using the whiteboard. For example, some users like to generate PDF document files from own hand-drawn contents, and some users like to generate editable word files from own speech teaching contents. Based on the preference information of the users, the matching degree of the preferred preset file template can be adjusted to the highest or increased to a certain extent, thereby making it easier to recommend the preset file template preferred by the users.

In addition, the user information of the current user can be determined through an electronic whiteboard system by a current account logged in by the user, or the identity information or identity features of the user can be determined through an internal or external camera of the electronic whiteboard in a face recognition mode. For the traditional whiteboards, the current user and the user information thereof can be determined through the external camera or a pickup device and in a mode of face recognition or voiceprint recognition.

For how to correct the matching degree between the input contents and each preset file template based on the preference information and through the deep learning mode, the following implementation process can be included:
Basic process: content feature extraction →similarity calculation→template sorting→automatic matching.

Application scenario: the best output format (such as Gantt chart or mind map) is automatically selected.

Recommendation algorithms based on reinforcement learning, such as using the Q-learning method to optimize the recommendation of the preset file template, can firstly use cosine similarity to measure the matching degree between the input contents and the preset file template, that is, calculate the similarity between the contents and the template based on cosine similarity. The comparison of template embedding vectors is achieved using PyTorch. A reward signal of Q-learning can be determined by the user preference for historically selected file templates or freely preset output file templates, to continuously optimize the accuracy of template recommendations.

Wherein cosine similarity is used for measuring the matching degree between the input contents and the preset file template to ensure the relevance of the recommendation results, and further, based on template optimization of contrastive learning, contrastive loss is used for template optimization of the recommendations based on similarity. In addition, Faiss can also be used to quickly retrieve similar file templates.

In the process of practical application, the template recommendation system of the whiteboard recommends appropriate output formats (such as Gantt chart or mind map) for the users or puts forward suggestions for intelligent output formats according to the features of the input contents.

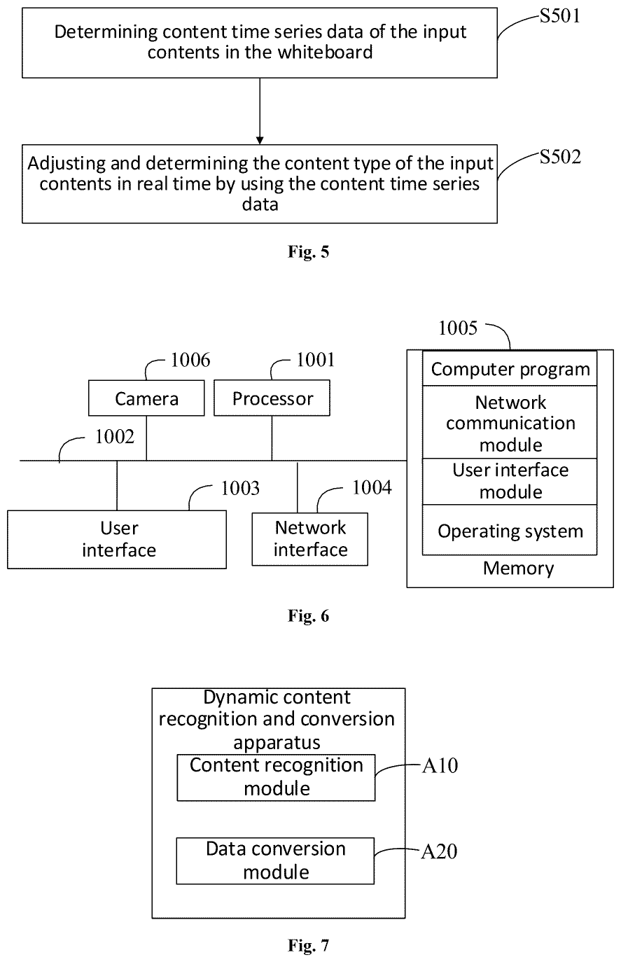

For a dynamic content recognition and conversion method provided by the present application, in one specific embodiment, by referring to FIG. 5, FIG. 5 is a flow chart 5 of a dynamic content recognition and conversion method shown in another exemplary embodiment of the present application.

The dynamic content recognition and conversion method comprises:
Step S501: determining content time series data of the input contents in the whiteboard;
Step S502: adjusting and determining the content type of the input contents in real time by using the content time series data;
Step S503: determining a target conversion file of the input contents by using the content type.

In the present embodiment, considering that the input contents may be modified, deleted, added, etc. at any time, it is necessary to dynamically adjust and determine the content type of the input contents in real time according to the changes of the input contents. Thus, the process and results of recognizing the input contents can be continuously learned and optimized through the deep learning mode. Specifically, taking the hand-drawn information as an example, the content time series data of the hand-drawn information, i.e., the hand-drawn data at each collection moment, is acquired. Based on the content time series data, the sequence of writing and drawing on the whiteboard is analyzed through a deep learning model, and stroke changes, writing directions and content structures are recorded, so as to determine the content type of the input contents in real time. As the hand-drawn data is increased, the content type can be recognized more accurately, to determine the true intention of hand drawing of the user and a required target conversion file.

For the hand-drawn information, the corresponding dynamic recognition process is: handwriting capture →time series analysis→model learning and recognition→content classification and structure optimization.

More specifically, the data features in the hand-drawn information are extracted. Through a stroke vectorization technology, handwriting is converted into a digital sequence, i.e., content time series data. Then, the convolutional neural network (CNN) and the recurrent neural network (RNN) are applied to classify the digitized handwriting, so as to determine drawing and writing sequences in real time based on the content time series data to speculate the flow chart and structured information. Finally, the preset file template corresponding to the determined content type can be retrieved to generate the target conversion file corresponding to the hand-drawn information. For example, manually drawn flow charts and structure diagrams are converted into electronic flow charts, structure diagrams and other charts in corresponding standardized data formats, such as charts or graphic structures in Visio or CAD format.

For example, corresponding application scenarios can comprise: recognizing key stages of meeting discussion, such as brainstorming, planning, decision making, etc.

The embodiments of the present application also propose a dynamic content recognition and conversion device. The dynamic content recognition and conversion device can be an electronic whiteboard, a conference tablet, a smart television, a computer or other display and data processing devices.

As shown in FIG. 6, FIG. 6 is a structural schematic diagram of a hardware operating environment of a dynamic content recognition and conversion device involved in a solution of an embodiment of the present application.

As shown in FIG. 6, the dynamic content recognition and conversion device can comprise: a processor 1001 such as CPU, a network interface 1004, a user interface 1003, a memory 1005, a communication bus 1002 and a camera 1006, wherein the communication bus 1002 is used for realizing connection communication between the components. The user interface 1003 can comprise a display and an input unit such as a control panel. Optionally, the user interface 1003 can also comprise a standard wired interface and a standard wireless interface. Optionally, the network interface 1004 can comprise a standard wired interface and a standard wireless interface (such as a Wi-Fi interface). The memory 1005 can be a high-speed RAM or a stable memory (non-volatile memory) such as a disk memory. Optionally, the memory 1005 can also be a storage apparatus independent of the processor 1001. The memory 1005 as a computer storage medium can comprise a dynamic content recognition and conversion program, wherein the camera 1006 can be a red-green-blue (RGB) camera.

Those skilled in the art can understand that the hardware structure shown in FIG. 6 does not limit the device and can comprise more or fewer components than those shown in the figure or combine certain components or different component arrangements.

Also referring to FIG. 6, the memory 1005 as a computer readable storage medium in FIG. 6 can comprise an operating apparatus, a user interface module, a network communication module and a dynamic content recognition and conversion program.

In FIG. 6, the network communication module is mainly used for connecting with a server and can conduct data communication with the server; and the processor 1001 can invoke the dynamic content recognition and conversion program stored in the memory 1005 and perform the steps in each of the above embodiments.

The hardware structure based on the dynamic content recognition and conversion device is used for implementing each embodiment of the dynamic content recognition and conversion method of the present application.

In addition, the present application further provides a dynamic content recognition and conversion apparatus. Referring to FIG. 7, the dynamic content recognition and conversion apparatus comprises:
a content recognition module A10 used for determining input contents and a content type thereof in a whiteboard;
a data conversion module A20 used for determining a target conversion file of the input contents by using the content type.

Further, the content recognition module A10 is also used for:
recognizing the input contents in the whiteboard in real time and determining a matching degree between the input contents and each preset file template;
determining a file type of a target preset file template with a highest matching degree as the content type of the input contents.

Further, the data conversion module A20 is also used for:
mapping the input contents to the target preset file template to generate the target conversion file in a corresponding document format.

Further, the content recognition module A10 is also used for:
determining user information of a current user using the whiteboard;
correcting the matching degree between the input contents and each preset file template by using preference information in the user information.

Further, the content recognition module A10 is also used for:
determining content time series data of the input contents in the whiteboard;
adjusting and determining the content type of the input contents in real time by using the content time series data.

Further, the content recognition module A10 is also used for:
determining word information in the hand-drawn information by using optical character recognition;
determining the content type corresponding to the word information by using natural language processing.

Further, the content recognition module A10 is also used for:
determining graphic information in the hand-drawn information by using image recognition;
determining the content type corresponding to the graphic information by using a deep learning model.

Further, the content recognition module A10 is also used for:
segmenting the graphic information by using a Mask R-CNN model and determining geometry structures in the graphic information by using a YOLO algorithm;
determining the content type corresponding to the graphic information by using each geometry structure.

Further, the content recognition module A10 is also used for:
determining text data, speech data and geometry data in the hand-drawn information, the speech information and the text information;
determining the content type corresponding to the multimodal information in combination by using the text data, the speech data, the geometry data and respective modal weights.

The specific implementation modes of the dynamic content recognition and conversion apparatus of the present application are basically the same as the embodiments of the dynamic content recognition and conversion method, which will not be repeated here.

In addition, the present application further provides a computer readable storage medium. The computer readable storage medium of the present application stores computer programs, and the computer programs can include the dynamic content recognition and conversion program, wherein the dynamic content recognition and conversion program, when executed by a processor, implements the steps of the dynamic content recognition and conversion method.

Wherein the method implemented when the dynamic content recognition and conversion program is executed can be referred to the embodiments of the dynamic content recognition and conversion method of the present application, which will not be repeated here.

In addition, the present application further provides a computer program product, the computer program product comprises computer program codes, and the computer program codes, when running on a computer, make the computer execute the dynamic content recognition and conversion method in each of the above embodiments.

It should be noted that the sequential order of the above embodiments of the present application is only for description and does not represent the superiority or inferiority of the embodiments. The process depicted in the drawings does not necessarily require a specific sequence or consecutive sequence to achieve desired results. In some embodiments, multi-task processing and parallel processing are also possible or may be advantageous.

Each embodiment in the description is described in a progressive way. The same and similar parts among all of the embodiments can be referred to each other. The difference of each embodiment from each other is the focus of explanation.

Those skilled in the art should understand that the embodiments of the present application can provide a method, apparatus or computer program product. Therefore, the present application can adopt a form of a full hardware embodiment, a full software embodiment or an embodiment combining software and hardware. Moreover, the present application can adopt a form of a computer program product capable of being implemented on one or more computer available storage media (including but not limited to disk memory, CD-ROM, optical memory, etc.) containing computer available program codes.

The above only describes preferred embodiments of the present application, but is not intended to limit the protection scope of the present application. Under the application conception of the present application, equivalent structure/method transformation made by using contents of the description and drawings of the present application, or directly/indirectly used in other relevant technical fields shall be included within the protection scope of the present application.

1. A dynamic content recognition and conversion method, wherein applied to a whiteboard, comprising:
determining input contents and a content type thereof in a whiteboard;
determining a target conversion file of the input contents by using the content type;
the input contents comprise at least one of hand-drawn information, speech information and text information;
the content type comprises at least one of a table, a presentation, a text document and a digital chart.

2. (canceled)

3. (canceled)

4. The dynamic content recognition and conversion method according to claim 1, wherein the digital chart comprises at least one of a flow chart, a Gantt chart, a mind map, a decision tree diagram, a data flow diagram, an organization chart, a tree structure diagram and a network topology diagram.

5. The dynamic content recognition and conversion method according to claim 1, wherein determining input contents and a content type thereof in a whiteboard comprises:
recognizing the input contents in the whiteboard in real time and determining a matching degree between the input contents and each preset file template;
determining a file type of a target preset file template with a highest matching degree as the content type of the input contents.

6. The dynamic content recognition and conversion method according to claim 5, wherein determining a target conversion file of the input contents by using the content type comprises:
mapping the input contents to the target preset file template to generate the target conversion file in a corresponding document format.

7. The dynamic content recognition and conversion method according to claim 5, wherein recognizing the input contents in the whiteboard in real time and determining a matching degree between the input contents and each preset file template further comprises:
determining user information of a current user using the whiteboard;
correcting the matching degree between the input contents and each preset file template by using preference information in the user information.

8. The dynamic content recognition and conversion method according to claim 1, wherein determining input contents and a content type thereof in a whiteboard comprises:
determining content time series data of the input contents in the whiteboard;
adjusting and determining the content type of the input contents in real time by using the content time series data.

9. The dynamic content recognition and conversion method according to claim 1, wherein the input contents comprise the hand-drawn information, and determining input contents and a content type thereof in a whiteboard comprises:
determining word information in the hand-drawn information by using optical character recognition;
determining the content type corresponding to the word information by using natural language processing.

10. The dynamic content recognition and conversion method according to claim 1, wherein the input contents comprise the hand-drawn information, and determining input contents and a content type thereof in a whiteboard comprises:
determining graphic information in the hand-drawn information by using image recognition;
determining the content type corresponding to the graphic information by using a deep learning model.

11. The dynamic content recognition and conversion method according to claim 10, wherein determining the content type corresponding to the graphic information by using a deep learning model comprises:
segmenting the graphic information by using a Mask R-CNN model and determining geometry structures in the graphic information by using a YOLO algorithm;
determining the content type corresponding to the graphic information by using each geometry structure.

12. The dynamic content recognition and conversion method according to claim 1, wherein the input contents comprise multimodal information composed arbitrarily of the hand-drawn information, the speech information and the text information; and determining input contents and a content type thereof in a whiteboard comprises:
determining text data, speech data and geometry data in the hand-drawn information, the speech information and the text information;
determining the content type corresponding to the multimodal information in combination by using the text data, the speech data, the geometry data and respective modal weights.

13. A dynamic content recognition and conversion apparatus, comprising:
a content recognition module used for determining input contents and a content type thereof in a whiteboard;
a data conversion module used for determining a target conversion file of the input contents by using the content type;
the input contents comprise at least one of hand-drawn information, speech information and text information;
the content type comprises at least one of a table, a presentation, a text document and a digital chart.

14. A dynamic content recognition and conversion device, wherein comprising a processor, a memory and computer programs stored in the memory and capable of being executed by the processor, wherein the computer programs, when executed by the processor, implement the steps of the dynamic content recognition and conversion method according to claim 1.

15. A computer readable storage medium, storing computer program instructions, wherein the computer program instructions, when executed by a processor, implement the steps of the dynamic content recognition and conversion method according to claim 1.

16. A computer program product, wherein the computer program product, wherein when run on a computer, makes the computer execute the dynamic content recognition and conversion method according to claim 1.

17. A dynamic content recognition and conversion device, comprising a processor, a memory and computer programs stored in the memory and capable of being executed by the processor, wherein the computer programs, when executed by the processor, implement the steps of the dynamic content recognition and conversion method according to claim 4.

18. A dynamic content recognition and conversion device, comprising a processor, a memory and computer programs stored in the memory and capable of being executed by the processor, wherein the computer programs, when executed by the processor, implement the steps of the dynamic content recognition and conversion method according to claim 5.

19. A computer readable storage medium, storing computer program instructions, wherein the computer program instructions, when executed by a processor, implement the steps of the dynamic content recognition and conversion method according to claim 4.

20. A computer readable storage medium, storing computer program instructions, wherein the computer program instructions, when executed by a processor, implement the steps of the dynamic content recognition and conversion method according to claim 5.

21. A computer program product, wherein the computer program product, wherein when run on a computer, makes the computer execute the dynamic content recognition and conversion method according to claim 4.

22. A computer program product, wherein the computer program product, wherein when run on a computer, makes the computer execute the dynamic content recognition and conversion method according to claim 5.
